(19) United States
(12) Patent Application Publication
(10) Pub. No.: US 2012/0144846 A1
(43) Pub. Date: Jun. 14, 2012

(54) System and Method for Accumulating Pressurized Liquefied Gases

(76) Inventor: Ralph Johanson, Davenport, IA (US)

(21) Appl. No.: 13/391,068

(22) PCT Filed: Aug. 20, 2010
(86) PCT No.: PCT/US2010/046165

§ 371 Date: Feb. 17, 2012

Related U.S. Application Data
(60) Provisional application No. 61/235,587, filed on Aug. 20, 2009.

(51) Int. Cl. F17C 5/00; F17C 13/02; F17C 7/02

(52) U.S. Cl. 62/50.5; 62/51.1

(57) ABSTRACT

A system and method for accumulating pressurized liquefied gas or cryogenic fluids in which a source supply of liquefied gas or cryogenic fluid is fed to a pump which pressurizes the fluid and feeds it to a liquid accumulator. The pump also feeds a first vaporizer which vaporizes the fluid and feeds it into the headspace of the liquid accumulator thereby building pressure in the liquid accumulator. The pressurized liquid is then fed to a second vaporizer where the pressurized liquid is vaporized before use.

### CROSS-REFERENCE TO RELATED APPLICATIONS

Applicant hereby claims the benefit of PCT application, Application No. PCT/US2010/046165, filed Aug. 20, 2010, which claims priority to an earlier filed provisional application, Application No. 61/235,587, filed Aug. 20, 2009, incorporated herein by reference.

### TECHNICAL FIELD

This disclosure relates generally to cryogenic pressurization systems. More particularly, the present disclosure relates to a system and method for accumulating pressurized liquefied gases for downstream use.

### BACKGROUND

Cryogenic fluids and liquefied gases (referred to collectively throughout this disclosure as liquefied gases), that is, fluids having a boiling point generally below −150° F. at atmospheric pressure, are used in a variety of applications. As an example, laboratories and industrial plants use nitrogen in both liquid and gas form for various processes.

Liquefied gases are typically stored as liquids that require pressurization and sometimes heating prior to usage. The liquid nitrogen stored by laboratories and industrial plants typically must be pressurized prior to use as a gas or liquid.

In other systems, the liquefied gas is converted to the gaseous phase and stored at a high pressure before the end-use application. Because the gas phase is less dense, the volume of these tanks had to be larger to store the necessary amount of gas phase liquefied gas to meet the pressure and volume requirements of the end-use application. Storing large amounts of high-pressure gas phase material required specialized and often expensive equipment. In addition, such storage poses a safety concern as the large gas accumulators store gas phase liquefied gas at relatively high pressures often around 3000 psig (pounds per square inch gauge) to accommodate the end-use application. There are a number of disadvantages of such systems. Storage tanks for pressurized gaseous phase liquefied gas are often bulky and have a large footprint. This is due in part to the increased volume of the gaseous phase as opposed to the liquids phase. In addition, such storage tanks are often expensive. In view of these disadvantages, it would be desirous for a system to accommodate the pressure and volume needs of an end-use application as well as reducing the expense, bulk, and danger of the system that provides the vaporized liquefied gas for the end-use application.

### SUMMARY OF THE INVENTION

In accordance with one aspect of the invention, a system is provided that includes a supply of liquefied gas or cryogenic liquid. The liquid is supplied to a pump which builds pressure in the fluid stream. A liquid accumulator vessel collects liquid from the pump and is pressurized by vaporized fluid from a vaporizer that is also supplied by the pump. The vaporized fluid is added to the headspace of the accumulator to pressurize the liquid contents in the accumulator. A control system controls the parameters of the system to produce the desired pressure and flow of the output of the pressurized liquid, which is vaporized in a second vaporizer for use in an end-use application.

A method of the present invention comprising a supply source of a liquefied gas or cryogenic liquid in substantially a liquid state. A pump is fluidly connected to the supply source which in turn is fluidly connected to a liquid accumulator, a first vaporizer, and a second vaporizer. Liquid from the pump can be vaporized in the first vaporizer and fed into the headspace of the liquid accumulator to pressurize the liquid in the accumulator. Liquid from the pump may also be fed directly to the liquid accumulator or may bypass both the first vaporizer and the liquid accumulator and be supplied directly to the second vaporizer. Pressurized liquid from the liquid accumulator may also be supplied to the second vaporizer to produce pressurized vaporized liquefied gas or cryogenic liquid to an end-use application. A control system controls the operation and flow of the liquefied gas or cryogenic fluid and the vaporization of the same.

### BRIEF DESCRIPTION OF THE DRAWINGS

FIG. 1 is a schematic overview of a system for accumulating pressurized liquefied gases according to one embodiment of the invention.

### DETAILED DESCRIPTION OF THE PREFERRED EMBODIMENT

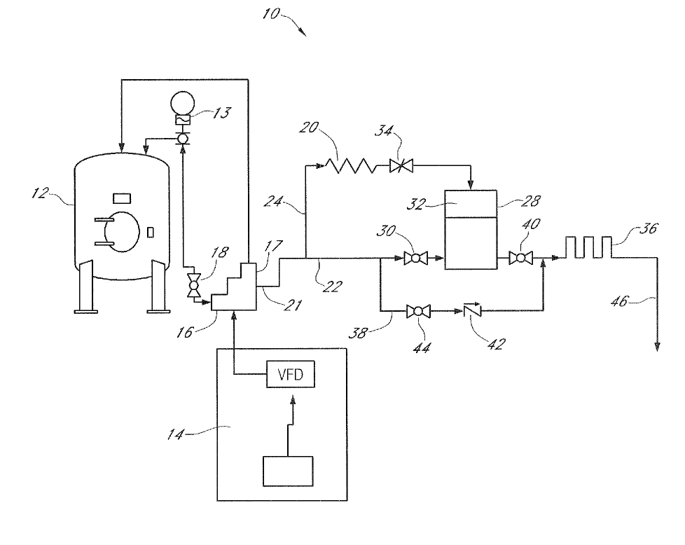

FIG. 1 shows one embodiment of the present invention which is a system for accumulating pressurized liquefied gases. System 10 includes a bulk storage tank 12 but can include any other supply means of storing liquefied gas in either bulk or otherwise. The pressure of such stored liquefied gases is usually between 30-600 psig. Storage tank 12 includes vents 13 which may be controlled by control system 14 for venting the storage tank 12 under preprogrammed or preset conditions such as temperature or pressure settings as is commonly known in the art. Such preprogrammed or preset conditions are usually determined by the construction of the vessel and/or the properties of the liquefied gas. Storage tank 12 is in fluid connection with a pump 16 via a valve 18 which is commonly known in the art and which may be replaced with any suitable means to supply liquefied gas from the storage tank 12 to the pump 16. Pump 16 can be any type of pump commonly used in the art, including a positive displacement pump. The operation of pump 16 is controlled by control system 14 which may include a programmable logic controller (PLC) and a variable frequency drive (VFD). Sensors in the system (not shown) provide feedback to the control system 14 to ensure that the proper quality of liquefied gas remains in the pump 16 to prevent cavitation of the pump 16 which would be detrimental to the process. Pump 16 also may be used to increase the pressure of the liquefied gas. Generally, pump 16 will increase the pressure of the liquefied gas to a pressure of 400 to 3000 psig, though other pressures are contemplated by this invention. Pump 16 is fluidly connected to both the liquid accumulator 28 and a pressure building process vaporizer 20 via supply line 21 which diverges into two supply lines 22, 24. Liquefied gas exiting the pump 16 will most often have at least some gaseous phase liquefied gas included from the exposure to ambient air or the temperature increase that occurs during pumping and/or transmittal. The composite mixture of liquid and gas phase liquefied gas enters supply line 21 and is directed to supply lines 22, 24 by the control system 14. Control system 14 uses end-use application requirements as well as system feedback to determine the flow path of the composite fluid exiting the outlet side 17 of the pump 16. A portion of such composite fluid may be directed to both supply lines 22 and 24, or the composite fluid may be directed to only one of the supply lines. Supply line 22 is fluidly connected to the liquid accumulator 28 via a regulator or valve 30 as is commonly known in the art. Any suitable regulator or valve may be used and may be controlled by control system 14 or other suitable means including manually. Liquefied gas (or the composite fluid) can be supplied from bulk storage tank 12 through the pump 16 to the liquid accumulator 28. Supply line 24 supplies liquefied gas (or the composite fluid) from the outlet side 17 of the pump 16 to a pressure building process vaporizer 20. The pressure building process vaporizer 20 may be of any kind that is suitable for vaporizing liquefied gas or cryogenic fluid and such vaporizers are commonly known in the art. One type of vaporizer that is used is a fin-type heat exchanger that uses only ambient air to vaporize the liquefied gas. However, other suitable vaporizers are contemplated by this invention. The liquefied gas that is directed to the pressure building process vaporizer 20 by the control system 14 through the operation of valve 30 is thus heated thereby changing the phase of the material from liquid to gas or at least a portion of the fluid undergoes a phase change from liquid to gas. The pressure building process vaporizer 20 is fluidly connected to the headspace 32 of the liquid accumulator 28. The vaporized liquid passes through a control valve 34 or other suitable means of controlling flow, which can be controlled by the control system 14. The vaporized liquefied gas is then fed into the headspace 32 of the liquid accumulator 28 thereby exerting pressure on the liquid portion of the contents of the liquid accumulator 28. The pump 16 is also in fluid connection with the liquid accumulator 28. Liquefied gas, or the composite mixture exiting the outlet side 17 of the pump 16 can be directed into the liquid accumulator 28 by the control system 14 to ensure a proper volume of liquid in the accumulator 28.

For some end-use applications, the liquefied gas may bypass the liquid accumulator 28 through the use of a valve 44 and/or check valve 42 or any other suitable means that is commonly known in the art. In such applications, the liquid accumulator 28 may be used to manage and normalize flow from the pump 16 to an ambient air heat exchanger 36. The ambient air heat exchanger 36 can be any type of vaporizer commonly known in the art and is not limited to an ambient air exchanger.

In one aspect of the invention, liquefied gas may be fed into the liquid accumulator 28 to a level detected and controlled by control system 14. Vaporized liquefied gas may be fed into the headspace 32 of the liquid accumulator 28 which can also be measured and controlled by the control system 14. The pressure exerted on the liquid phase of the contents of the liquid accumulator 28 will increase the pressure with which the liquid phase exits the liquid accumulator 28. The pressure and volume requirements of the end-use application can be used by the control system 14 to control the various valves to adjust the ratio of vaporized liquefied gas to liquid phase liquefied gas in the liquid accumulator 28. The liquid accumulator 28 is in fluid connection with ambient air heat exchanger 36 which is also fluidly connected to bypass line 38. A valve 40 is disposed between the liquid accumulator 28 and the ambient air heat exchanger 36. The bypass line 38 has a check valve 42 and a valve 44 to bypass the accumulator 28 under preset conditions as may be determined by the control system 14 or by the valve specifications. The ambient air heat exchanger 36 may be of any kind known in the art including the fin-type heat exchanger discussed above, and is used to convert the liquid phase liquefied gas into the gas phase before the end-use application which may be any of a number of applications including industrial applications. The liquid phase liquefied gas exiting the liquid accumulator 28 is under pressure from the pressure exerted on it from the vaporized liquefied gas in the headspace 32 of the liquid accumulator 28. When the pressurized liquid phase liquefied gas exits the liquid accumulator 28 it is in turn vaporized in the ambient air heat exchanger 36. After the liquefied gas is vaporized, the vaporized liquefied gas can be supplied to the end-use application via supply line 46. Alternatively, the liquid phase liquefied gas from the liquid accumulator 28 may be supplied to the ambient air heat exchanger 36 and then used directly in the end-use application via supply line 46. In yet another alternative, the liquefied gas from the outlet side 17 of the pump 16 can be supplied to the ambient air heat exchanger 36 and then used directly in the end-use application via supply line 46.

It can be seen from one skilled in the art that the present system provides a number of advantages. The invention of the present disclosure eliminates the need for large volume gas phase accumulators by instead using a liquid accumulator 28. The end-use application pressure requirements can still be met by vaporizing the liquid stored in the liquid accumulator 28. Moreover, the control system 14 can adjust the system to accommodate the requirements of the end-use application. For example, if the application requires a higher pressure of the gas phase at the supply line 46, then more of the liquefied gas from the outlet side 17 of the pump 16 is fed into the pressure building process vaporizer 20 which is then supplied to the headspace 32 of the liquid accumulator 28. This in turn pressurizes the liquid phase present in the accumulator 28. When that higher-pressure liquid phase is then vaporized in the ambient air heat exchanger 36, it allows a supply of higher-pressure gaseous phase liquefied gas to be used by the end-use application via supply line 46.

In previous systems, accumulating a pressurized liquefied gas was not feasible or suitable because pressurizing the liquefied gas would often lead to an increase in the temperature of the liquefied gas and vaporization thereof, In addition, many current systems use the liquefied gas stored in the accumulation tank, vaporize it, and return it to the tank to build pressure in the accumulator. The system of the present invention does not utilize the liquefied gas from the accumulator tank to build pressure, but rather, uses liquefied gas from the bulk tank to both maintain the liquid level and the pressure in the accumulator. This allows for the entirety of the contents of the liquid phase in the accumulator tank to be used for the end-use application rather than for building pressure, thereby increasing the efficiency of the system.

Those skilled in the art will recognize that numerous modifications can be made to the specific implementations described above. Therefore, the following claims are not to be limited to the specific embodiments illustrated and described above. The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

I claim:

1. A system for accumulating pressurized liquefied gases comprising:
a source of cryogenic liquid or refrigerated liquid;
a pump fluidly connected with the source;
an accumulator, the accumulator having a headspace and fluidly connected to the pump;
a pressure-building vaporizer, the vaporizer fluidly connected to the pump and connected to the headspace of the accumulator;
a second vaporizer, the second vaporizer fluidly connected to the pump and to the accumulator; and
a control system wherein the control system determines the flow of the liquid through the pump to the accumulator and vaporizer.

2. The system of claim 1, wherein the accumulator contains a volume of liquid phase cryogenic liquid or refrigerated liquid and a volume of gas phase cryogenic liquid or refrigerated liquid, wherein the volume of the gas phase is supplied from the pressure building vaporizer.

3. The system of claim 2, wherein the volume of gas phase in the accumulator is increased to increase pressure on the volume of liquid phase in the accumulator.

4. A system for accumulating pressurized liquefied gas or cryogenic fluid comprising:
a volume of liquefied gas or cryogenic fluid;
a pump;
a vessel having a headspace, an inlet side, and an outlet side fluidly connected to said pump on the inlet side;
a vaporizer, fluidly connected to the outlet side of the vessel;
and
a control system, wherein the control system determines the amount of the volume of liquefied gas or cryogenic fluid that is supplied to the inlet side and outlet side of the vessel.

5. The system of claim 4, further comprising:
a second vaporizer fluidly connected to the headspace of the vessel;
wherein a volume of liquefied gas or cryogenic fluid from the pump is vaporized in the second vaporizer and the vapor is supplied to the headspace of the vessel.

6. The system of claim 4, further comprising:
the pump and the vaporizer fluidly connected,
wherein the volume of liquefied gas or cryogenic fluid from the pump is supplied directly to the vaporizer.

7. A method for accumulating pressurized liquefied gas or cryogenic fluid comprising the steps of:
a) supplying liquefied gas or cryogenic fluid to a pump;
b) pressurizing the liquefied gas or cryogenic fluid in the pump;
c) supplying a volume of the liquefied gas or cryogenic fluid to a first vaporizer;
d) supplying a volume of liquefied gas or cryogenic fluid to a liquid accumulator;
e) vaporizing the volume of liquefied gas or cryogenic fluid;
f) supplying the vaporized liquefied gas or cryogenic fluid to a headspace in the liquid accumulator to exert pressure on the volume of liquefied gas or cryogenic fluid supplied to the liquid accumulator; and
g) supplying a volume of liquefied gas or cryogenic fluid to a second vaporizer; and
h) vaporizing the volume of liquefied gas or cryogenic fluid in the second vaporizer.

8. The method of claim 7 further comprising:
using a control system to control the supply of liquefied gas or cryogenic fluid to and from the pump, first vaporizer, liquid accumulator and second vaporizer.
